(19) United States
(12) Patent Application Publication
(10) Pub. No.: US 2024/0246176 A1
(43) Pub. Date: Jul. 25, 2024

(54) METHOD FOR TREATMENT OF A SLIDING SURFACE ON METALLIC MACHINE PART

(71) Applicant: Mitjan KALIN, Log pri Brezovici (SI)

(72) Inventor: Mitjan KALIN, Log pri Brezovici (SI)

(21) Appl. No.: 18/552,607

(22) PCT Filed: Apr. 8, 2021
(86) PCT No.: PCT/SI2021/000004

§ 371 Date: Sep. 26, 2023

(30) Foreign Application Priority Data
Apr. 6, 2021 (SI) P-202100068

(51) Int. Cl. B23K 26/342; B33Y 10/00; B33Y 40/20; B33Y 80/00

(52) U.S. Cl. CPC B23K 26/342; B33Y 10/00; B33Y 40/20; B33Y 80/00

(57) ABSTRACT

The present disclosure provides a method for surface treatment of a sliding surface on a metallic machine part, wherein the flat sliding surface of each machine part may include a dimpled structure with a defined pattern of surface indentations of a predetermined depth, dimensions, and shape. The present disclosure may also include providing for a uniformly distributed layer of metallic particles across a pre-treated, flat and smooth sliding surface of each machine part which is surrounded by protective atmosphere, directing a laser beam towards each predetermined area on said surface of the machine part which is covered with said layer of metallic particles in powder form such that the powder particles in layer are completely or at least partially melted with the surface underneath, and removing any unfused metallic particles from the surface of the machine part, and applying a layer of metallic particles in powder form onto each surface.

### CROSS-REFERENCE TO RELATED APPLICATIONS

This application is a United States national phase application of co-pending International Patent Application No. PCT/SI2021/000004, filed on 8 Apr. 2021, which claims the benefit of Slovenia Patent Application No. P-202100068 filed 6 Apr. 2021, both of which are hereby incorporated by reference in their entirety.

### BACKGROUND

The present disclosure relates to a method for treatment of a sliding surface on a metallic machine part, namely on an external surface of a mechanically strained machine part, which may be subject to stress conditions while in contact with an opposite sliding surface of a corresponding machine part. During use, the sliding surface is exposed to friction and wear even if a layer of lubricant is used between the parts. According to the International Patent Classification, the present disclosure may relate to the field of treatment of metallic objects, especially treatment using a laser beam, in particular, where metallic materials in powder form are used.

The present disclosure is based on the problem of how to design a fast and economic method for treatment of a sliding surface on a metallic machine part. In particular, a flat pre-treated surface of each metallic machine part may include a dimpled structure with a defined pattern of surface indentations of pre-determined depth, dimensions and shape, and wherein no further processing of such a surface, would be required before the use of said part.

It is known to persons skilled in the art, that in order to improve tribological properties on contacting sliding surfaces of machine parts, a dimpled structure having a pattern of surface indentations may assist in retaining the lubricant within the indentations and reduce the areas which are actively in contact with each other. This may consequentially also reduce friction by insuring permanent lubricant coverage of the various surface areas in contact. Although even with satisfactory lubrication, certain shear forces resulting from the viscosity of the lubricant may occur, these can also be reduced. Accordingly, friction and wear resulting from contact forces on the surface of each machine part may be reduced.

The relevant background as described by the present disclosure, is disclosed in certain prior art documents, e.g. WO 2008/047 062 A3, and moreover also in technical literature and public available technical articles, e.g. Townsend A., et al., A Review of Surface Texture Metrology for Additive Manufacturing of Metal Parts, Precision Engineering 2016, each of which is incorporated by reference in its entirety.

It is also known from the state of the art, that a dimpled structure on sliding surfaces may be in the form of a pattern of surface indentations of predetermined depth, dimensions and shape, and can be realized in various ways. For example, indentations on the surface are made by using a laser i.e. by means of a laser beam, optionally a pulsing ray, that is directed from a suitable source towards each predetermined area on the surface of the metallic machine part in such a way that the material in the irradiated area on the surface of the machine part starts melting. This may create a crater of roughly circular shape and with at least roughly predetermined depth. Part of the melted material may exit the crater and is then deposited and accumulated above the plane of the sliding surface, which after cooling and solidification may form a rim around the crater as soon as the laser beam is turned off and which may remain on the sliding surface even after the solidification of the material. For this reason, sanding and sometimes even polishing of the sliding surface is still required after creation of the indentations is completed.

Extreme physical and chemical conditions and material processes, which usually occur during melting and solidification of the material by using a laser beam, may cause significant roughness and undulation, such as an unevenness of the treated surface and additionally can cause unpredictable orientation and configuration of the surface because of local modifications in the crystalline structure of the material in combination with significant variations in cooling conditions. The probability of generating defects and cracks within the surface layers of a material, treated in such a manner, is also exceptionally high. Thus, a so-called integrity, namely regularity of a surface structure after a treatment with a laser beam is generally significantly worse than by a mechanically treated surface, and is in such treatment expected to be within the μm or even in nm ranges. Such reduced integrity of the treated surface causes difficulties with determining and optimising other parameters, which needs to be taken into account when ensuring tribological characteristics of each machine part. It is commonly known that tribological characteristics e.g. a friction coefficient, wearing resistance, or the like, greatly depend on the integrity of the surface, namely the topography, texture, roughness and defects, as well as the mechanical properties of the material, such as hardness, strength and presence of inherent internal stresses due to differences in the microstructure of the material.

Moreover, a method for manufacturing of a component by means of generative treatment is disclosed in DE 10 2018 206 320 A1, which is incorporated by reference in its entirety.

The present disclosure generally refers to a method of treating of a sliding surface on a metallic machine part, namely where said machine part comprises a pre-treated, sufficiently flat and smooth sliding surface at room or increased temperature, which is lower than the temperature of plasticizing or melting point of the metallic material of the machine part and may be surrounded with a protective atmosphere. The sliding surface may be treated by directing laser beams towards predetermined areas on said surface for sufficient time to ensure melting of the metallic material on the surface of the machine part. The movement of said laser beam across the surface is predetermined and controlled, especially by using an appropriate computer algorithm, to achieve desired dimensions as well as to achieve a desired distribution and density of areas on the surface of the machine part, which are exposed to said laser beam.

The method as proposed by the present disclosure may comprise the following steps:
i) applying a uniformly distributed layer of metallic particles in powder form with a predetermined and uniform thickness across said pre-treated, flat and smooth sliding surface of the machine part, which is surrounded by said protective atmosphere;
ii) directing said laser beam towards a predetermined area on said surface of the machine part, which is covered with a layer of metallic particles in powder form, for a sufficient time period such that the powder particles together with the surface underneath are completely or at least partially melted and may fuse with each other and directly or indirectly also with the material of said surface, which is optionally followed by moving the laser beam towards the next area on said surface of the machine part, covered with a layer of metallic particles in powder form;
iii) optionally removing any remaining metallic particles in powder form of said layer, which remain unfused i.e. unconnected with each other or the surface of each machine part, from the surface of said machine part;
iv) optionally installing an additional uniformly distributed layer of metallic particles in powder form with a predetermined and uniform thickness over a previously melted and solidified layer on the pre-treated, flat and smooth sliding surface of each machine part, being surrounded by said protective atmosphere, wherein the thickness or composition of each additional layer can differ from the thickness or composition of each previous layer, which is again followed by exposure to said laser beam according to said step ii); and
v) finally removing all remaining unfused i.e. unconnected metallic particles in powder form from the surface of each machine part.

In a preferred embodiment of the method according to the present disclosure said metallic particles in powder form in each layer applied to each surface are nanoparticles with a chemical composition which is at least approximately similar to the chemical composition of the sliding surface of the machine part.

In an alternative embodiment of the method according to the present disclosure, said metallic particles in powder form in each layer applied to each surface are nanoparticles with a chemical composition which differs from the chemical composition of the machine part in the area of its sliding surface, however upon melting forms an alloy or at least enables fusing of particles with each other and with the material of the machine part.

The thickness of each applied layer of metallic particles in powder form on said sliding surface of the machine part may be within a range between 5 and 100 μm. Furthermore, in said step ii) the laser beam may be directed towards the layer of metallic particles in powder form on said pre-treated flat and smooth sliding surface of the machine part within an area, the largest dimension of which is 40-100 μm. Additionally, in step ii) between each neighbouring laser treated areas there are remaining untreated areas, which have not been exposed to the laser beam and the smallest dimension of which, when observed on said surface, is 5-50 μm. In order to generate a suitable laser beam, a laser with a power of 100-1000 W and laser beam movement speed of 50-5000 mm/s is used, so that the temperature in each exposed area should exceed at least 2000° C., and the intensity of treatment of the material in powder form said layer is at least 15-20 cm³/h. The protective atmosphere at least substantially consists of an inert gas or a mixture of inert gases.

### BRIEF DESCRIPTION OF THE DRAWINGS

The present disclosure will be explained in more detail with the following embodiments and in connection with the accompanying drawings, wherein

FIG. 1 is a schematic presentation of a chamber for performing surface treatment of each machine part using a method according to the present disclosure;

FIG. 2 is a cross section of a machine part treated by using said method; and

FIG. 3 is a schematical of a machine part according to FIG. 2, in isometric view.

### DETAILED DESCRIPTION

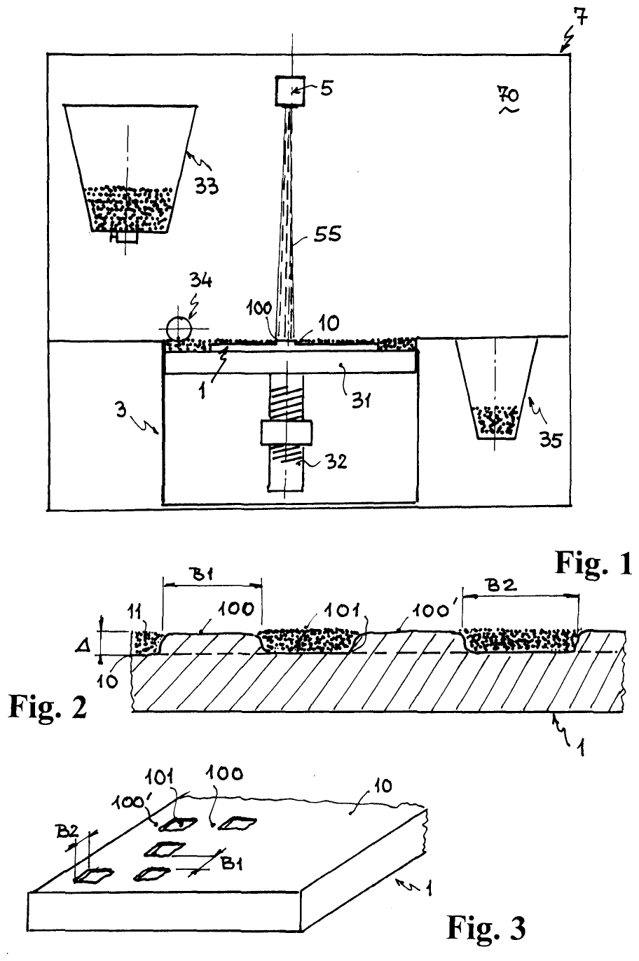

Method for treatment of a sliding surface 10 on a metallic machine part 1 can generally be carried out in an enclosed chamber 7 (FIG. 1), in which a protective atmosphere 70 can be established to prevent oxidation or similar chemical reactions in the material of machine part 1 in a heated or molten state with one or more ingredients of the atmosphere during treatment.

Each metallic machine part 1 is pre-treated and comprises a sufficiently flat and smooth sliding surface 10 which may be prepared for further treatment according to the present disclosure. Treatment of said sliding surface 10 according to the present disclosure is carried out at room or increased temperature, which is lower than the temperature of plasticizing or melting point of the metallic material of machine part 1.

After said treatment, the sliding surface 10 is generally treated by directing of each laser beam 55 towards predetermined areas 100, 100′ on said surface 10. The laser beam 55 is directed towards each area 100, 100′ for sufficient time to cause melting of the metallic material on the surface 10 in each area 100, 100′ of each machine part 1, and also in the basic material of the machine part 1 underneath.

The laser 5, which is embedded within said chamber 7, is adjustable and controlled in such a way, that each movement of laser beam 55 across the surface 10 of each machine part 1 is predetermined and controlled, for example by using an appropriate computer algorithm, to achieve desired dimensions B1, B2 and the desired distribution and density of areas 100, 100′ on each surface 10 of each machine part 1.

The machine part 1 in the embodiment shown in FIG. 1 is placed onto a supporting plate 31 after being inserted into chamber 7. Said supporting plate 31 is installed in the tub 3, which is located inside said chamber 7 such that its height can be adjusted by using appropriate means of adjustment 32, which is shown in FIG. 1 for illustrative purposes as a screw spindle. Above said tub 3, inside the chamber, a container 33 is disposed for storage and supplying the metallic powder material. Said tub 3 further comprises a means 34 of uniformly distributing said powder material across the surface 10 of said machine part 1, which is shown in FIG. 1 for illustrative purposes as a cylinder. Additionally, said tub 3 comprises a collector 35 for collecting superfluous powder material.

The method of treatment according to the present disclosure, and in particular treatment of a mechanically pre-treated and thus sufficiently flat and smooth surface 10 of machine part 1, is carried out after the mounting of machine part 1 onto said supporting plate 31, which is then followed by closing the chamber 7 and establishing the suitable protective atmosphere 70 inside of the chamber 7.

In the first step of the treatment, a uniformly distributed layer 11 of metallic particles in powder form is applied with a predetermined and uniform thickness A (FIG. 2) across said pre-treated, flat and smooth sliding surface 10 of each machine part 1, surrounded in said protective atmosphere 70. In some cases, when the surface 10 is aligned with the upper plane of tub 3, this is achieved by moving the supporting plate 31 downwards for a distance of A, such that the supporting plate 31 is located at distance A below the upper plane of tub 3. Afterwards, the metallic material in powder form is supplied onto the surface of tub 3 from container 33, which is subsequently, by using said means 34, uniformly distributed across the surface 10 of machine part 1. This is a simple way of creating a layer 11 of uniformly distributed metallic material in powder form with a predetermined and uniform thickness A. At the same time, superfluous powder particles are deposited in said collector 35.

In the second step according to the present disclosure, when the laser 5 is activated, a laser beam 55 is directed towards the predetermined area 100 on said surface 10 of each machine part 1 covered with a layer 11 of metallic particles in powder form, for such that the powder particles are at least partially melted together with the surface 10 underneath and may fuse with each other and directly or indirectly also with said surface 10, which is optionally followed by moving the laser beam 55 towards the next area 100′ on said surface 10 of each machine part 1, covered with a layer 11 of metallic particles in powder form.

The movement of the laser beam 55 is conducted with a predetermined speed along a predetermined path across the surface 10, such that the powder particles in layer 11 are melted and fused together with the surface 10 in predetermined areas 100, 100′, such that they become inseparably connected. The shape and size B1 of areas 100, 100′ can be determined in advance and can be either roughly round or roughly square or of any other desired and predetermined shape. It is therefore possible to create a predetermined pattern of elevations having a predetermined and uniform height on the surface 10. In the intermediate areas 101, which were not exposed to the effect of the laser beam 55 during operation of the laser 5, the layer 11 of metallic material in powder form at least partially retains its previous characteristics and powder particles in said areas 101 of pre-determined dimensions B2 remain unconnected with each other and with the surface 10 of the machine part 1, and can therefore be easily removed from said surface 10, which then leads to the desired indentations on the surface 10 of machine part 1. The removal of said free particles from layer 11 is presented in the third, optionally final step of executing the method according to the present disclosure.

The step of applying material in powder form can be repeated one or more times to form patterns on the surface 10, which might essentially exceed a suitable thickness A for each laser melting of said layer 11, such that after each movement of the supporting plate 31, for example for the distance A downwards again, another layer 11 of the material in powder form is applied across the machine part 1 of the same or different composition, the thickness of which is A after removing the excess material in powder form by using said means 34 in the area of the previously formed elevations. If after activation of the laser 5, the laser beam 55 is directed towards the same areas 100, 100′ as in the previous step, this again results in melting of the layer 11 of material in powder form only in predetermined areas 100, 100′ that are exposed to the laser beam 55, whereas such melting does not occur in other areas 101 which were not exposed to the effect of the laser beam 55. In the unexposed areas 100 the particles of layer 11 of material in powder form remain unconnected with each other and with the surface 10 of the machine part 1 and can be quickly and easily removed from the surface 10 of the machine part. In each area 101 of the surface 10 of machine part 1, an indentation remains with a flat bottom and of pre-determinable size B2, contour shape and depth.

In contrast to conventional laser treatment methods according to the state of the art, the method according to the present disclosure enables pre-determinable patterns consisting of indentations and elevations on the surface 10 of the machine part 1. Moreover, the effect of the laser beam 55 on the surface 10 is significantly more manageable and controlled, which prevents the occurrence of defects and cracks, and consequently leads to significantly better integrity of the surface, which means that further treatment of the surface 10 of machine part 1 is not required.

The metallic particles in powder form in each layer 11, applied to each surface 10, are either nanoparticles with a chemical composition which is at least approximately similar to the chemical composition of the sliding surface 10 of the machine part 1, or nanoparticles with a chemical composition which differs from the chemical composition of the sliding surface 10 of the machine part 1. In either case, however, melting the metallic particles allows formation of an alloy or at least enables fusing of particles with each other and with the material of the machine part 1.

In a preferred embodiment of the presented disclosure, the thickness A of each applied layer 11 of metallic particles in powder form on said sliding surface 10 of the machine part 1 is within a range between 5 and 100 μm. Furthermore, the laser beam 55 is always directed towards the layer 11 of metallic particles in powder form on said pre-treated flat and smooth sliding surface 10 of the machine part 1 within an area 100, 100′, the largest dimension B1 of which, when observed on said surface 10, is 40-100 μm. At the same time, between each neighbouring laser treated area 100, 100′ there are remaining untreated areas 101, which have not been exposed to the laser beam 55, the smallest dimension B2 of which, again when observed on said surface 10, is 5-50 μm.

In order to generate a laser beam 55 suitable for performing the method according to the present disclosure, a laser 5 with a power of 100-1000 W and laser beam 55 movement speed of 50-5000 mm/s is used, such that the achieved temperature in the exposed area exceeds at least 2000° C., and the intensity of treatment of the material in powder form in layer 11 is at least 15-20 cm³/h, wherein as mentioned before, said protective atmosphere 70 at least substantially consists of an inert gas or a mixture of inert gases.

What is claimed is:

1. A method of treating of a sliding surface on a metallic machine part which is suitable for sliding on a sliding surface of a machine counterpart, comprising steps of:
applying a uniformly distributed layer of metallic particles in powder form with a predetermined and uniform thickness across a pre-treated, flat and smooth sliding surface of the machine part, the layer surrounded by a protective atmosphere;
directing a laser beam towards each predetermined area on said surface of the machine part covered with a layer of metallic particles in powder form, such that the powder particles at least partially melt together with the surface underneath such that the particles fuse with each other and directly or indirectly also with said surface; and
removing any remaining unfused particles from the surface of the machine part,
wherein the thickness of each applied layer of metallic particles in powder form on said sliding surface of the machine part is between 5 and 100 μm,
wherein in the step of the directing the laser beam, the laser beam is always directed towards the layer of metallic particles in powder form on said pre-treated flat and smooth sliding surface of the machine part within an area having a largest dimension (B1) of which 40-100 μm,
and wherein in the step of the directing the laser beam, there are untreated areas between the treated areas which have not been exposed to the laser beam, the smallest dimension of which is 5-50 μm.

2. The method according to claim 1, further comprising:
placing an additional uniformly distributed layer of metallic particles in powder form with a predetermined and uniform thickness over a previously melted and solidified layer on the pre-treated, flat and smooth sliding surface of the machine part surrounded by said protective atmosphere, wherein the thickness or composition of each additional layer differs from the thickness or composition of each previous layer; and
removing all remaining unconnected metallic particles in powder form of said layer from the surface of the machine part.

3. The method according to claim 2, wherein metallic particles in powder form in each layer applied to said surface are nanoparticles with a chemical composition which is similar to the chemical composition of the machine part in the area of its sliding surface.

4. The method according to claim 2, wherein said metallic particles in powder form in each layer applied to the surface are nanoparticles with a chemical composition which differs from the chemical composition of the machine part in the area of its sliding surface.

5. The method according to claim 4, wherein the laser beam has a power of 100-1000 W a movement speed of 50-5000 mm/s such that the temperature in each exposed area exceeds 2000° C., and the intensity of treatment of the material in powder form in said layer is at least 15-20 cm³/h.
